(19) United States
(12) Patent Application Publication
(10) Pub. No.: US 2018/0009470 A1
(43) Pub. Date: Jan. 11, 2018

(54) CONTROL SYSTEM AND METHOD FOR ASSISTING OR OBTAINING A RELIABLE STEERING OPERATION OF A MOTOR VEHICLE WHICH IS CAPABLE OF DRIVING AT LEAST SEMI-AUTONOMOUSLY

(71) Applicant: Lucas Automotive GmbH, Koblenz (DE)

(72) Inventor: Manfred Meyer, Koblenz (DE)

(21) Appl. No.: 15/633,791

(22) Filed: Jun. 27, 2017

(30) Foreign Application Priority Data
Jul. 5, 2016 (DE) 10 2016 008 136.8

(51) Int. Cl. B62D 5/04; B60W 10/20; G05D 1/02; B62D 9/00; B62D 15/02; B60W 10/184; B60W 10/04

(52) U.S. Cl. CPC B62D 5/0484; B60W 10/184; B60W 10/20; B60W 10/04; B62D 9/00; B62D 15/025; G05D 1/021; B60W 2520/10; B60W 2520/105; B60W 2520/14; B60W 2520/26; B60W 2540/18; B60W 2710/182; B60W 2710/207; B60W 2520/28

(57) ABSTRACT

Control system and method which is adapted for use in a motor vehicle and intended to effect an at least semi-autonomous driving operation of the motor vehicle by means of assigned actuators on the basis of environmental data which are obtained from one or more environment sensors assigned to the motor vehicle, and wherein the control system is adapted and intended to detect a failure of a conventional steering system of the motor vehicle and attempt a change of direction of the vehicle, which corresponds to a desired steering angle, from current driving parameters by means of matched acceleration and/or deceleration interventions at individual wheel drives or wheel brakes, respectively, of the vehicle.

### BACKGROUND OF THE INVENTION

The invention relates to a control system and a method for assisting a reliable steering operation of a motor vehicle, in particular of a motor vehicle which is capable of driving at least semi-autonomously. This control system and method makes use in particular of the presence of individual brake control for each wheel in motor vehicles, both in passenger vehicles and in lorries (HGVs).

### SUMMARY OF THE INVENTION

The technology of motor vehicles which are capable of driving autonomously is developing rapidly. A large number of production vehicles are today already equipped with so-called “advanced driver-assistance systems”. These advanced driver-assistance systems take over various tasks and are intended to relieve the driver of or facilitate some activities, for example distance sensors for maintaining the safe distance between vehicles, or systems which intervene in vehicle guidance, such as electronically controlled antilock braking system (ABS), electronic stability programme (ESP), adaptive cruise control (ACC), lane departure warning system, parking assist system or automatic parking, etc. There are also the first fully autonomous vehicles, in which complex control systems with elaborate sensors and actuators take over the driving of the motor vehicle completely. In order to perform their tasks in autonomous vehicle operation, the autonomous motor vehicles have actuators and sensors, hardware and software and also a suitable system architecture. The actuators of (semi-)autonomous vehicles include, for example, electrically influenceable vehicle steering, a main engine and a gear box. There are, for example, also conventional steering arrangements with a steering wheel and steering gear which, independently of steering wheel movements by the driver, effect steering movements of the front wheels by means of electric or hydraulic actuators controlled by the autonomous vehicle controller.

A problem in autonomous motor vehicles is the situation in which a driver gives the motor vehicle full control over the guidance of the motor vehicle. In this case, the driver no longer has to have his hands on the steering wheel or his foot on the gas/brake pedal: he no longer has any Influence over the steering or the brakes of the motor vehicle. In fact, the driver in this situation also gives control over the steering and the brakes to the autonomous vehicle controller. If, then, the steering actuator/s or components of the autonomous vehicle controller upstream thereof fall during an autonomous steering operation, the driver is not always able to (re-)take control of the steering in time. This is impossible in any case in fully autonomous motor vehicles. A safety function for steering failures in motor vehicles is therefore very desirable.

The steerablilty of the autonomous motor vehicle is a property that is critical to the system. A redundant solution must therefore be provided. An obvious solution would be to duplicate the electric or hydraulic actuators and the control thereof for the steering movements of at least the front wheels of the motor vehicle. However, implementing such a solution increases the weight and is cost-intensive.

The solution proposed herein, in a surprising departure from the above duplicate solution, provides, for example in an exceptional situation, that a steering failure is compensated for in a way which, conceptually, is completely different. To that end, in the vehicle control system, when a failure of the conventional steering system is detected, a change of direction of the vehicle, which corresponds to a desired steering angle, is attempted from current driving parameters, such as, for example, vehicle speed, vehicle acceleration, yaw rate, desired and actual steering angle, etc., by means of matched acceleration and/or deceleration of individual wheel drives or wheel brakes, respectively, of the vehicle.

In short, the present solution implements steering by acceleration as redundancy architecture and is intended for use in different vehicle variants. The term “acceleration” here includes both positive acceleration and negative acceleration (=deceleration).

This solution makes use of the fact that, owing to the increasing Incidence of electronic stability control (ESC), more and mom vehicles have devices for driving dynamics control. Driving dynamics control refers to an electronically controlled driver assistance system for motor vehicles which counteracts pulling of the vehicle by purposive braking or deceleration of individual wheels. ESC is an extension and combination of the antilock braking system (ABS) with a traction control system (TCS) and an electronic brake force distribution system as well as with a brake assist system. In electric vehicles with individual electric drives for each wheel, purposive acceleration of individual wheels is additionally possible.

Some autonomous vehicle variants are not equipped with any conventional human-machine interfaces such as steering wheel, gas pedal, gear selector lever, dutch pedal, direction indicator lever, headlamp switch, etc. at all. Instead they have only control devices, sensors and actuators for automatically carrying out the respective function otherwise performed by the driver in driving operation of the passenger vehicle. The driver merely indicates the destination. The autonomous vehicle determines the route to the destination, pays attention to the environmental situation during the journey, avoids collisions, and also makes all other decisions which are usually incumbent upon the driver autonomously. The present solution is also suitable for such autonomous vehicle variants,

In some variants, vehicles are equipped with both conventional human-machine interfaces and corresponding control devices, sensors and actuators for automatically carrying out the respective function otherwise performed by the driver. The driver can here choose the degree to which he relies on the autonomous driving function of the passenger vehicle, or whether he intervenes in the autonomous driving operation of the passenger vehicle with, for example, steering, braking or acceleration interventions.

Both vehicle variants can have a drive train with a combustion engine, one or more electric motors or hybrid motors.

### BRIEF DESCRIPTION OF THE DRAWINGS

Further objects, features, advantages and possible uses will become apparent from the following description of embodiments, which are not to be interpreted as being limiting, with reference to the accompanying drawings. All the features described and/or illustrated, individually or in any desired combination, show the subject-matter disclosed herein independently of their grouping in the claims or their dependencies. The dimensions and proportions of the components shown in the figures are not necessarily true to scale; they may differ from those illustrated here in embodiments that are to be implemented.

FIG. 1 shows, in schematic form, parts of the control system architecture of a (semi-)autonomous passenger vehicle.

FIG. 2 shows, in schematic form, a model for lateral wheel steering to the left presented here.

FIG. 3 shows, in schematic form, a model for lateral wheel steering to the right presented here.

### DESCRIPTION

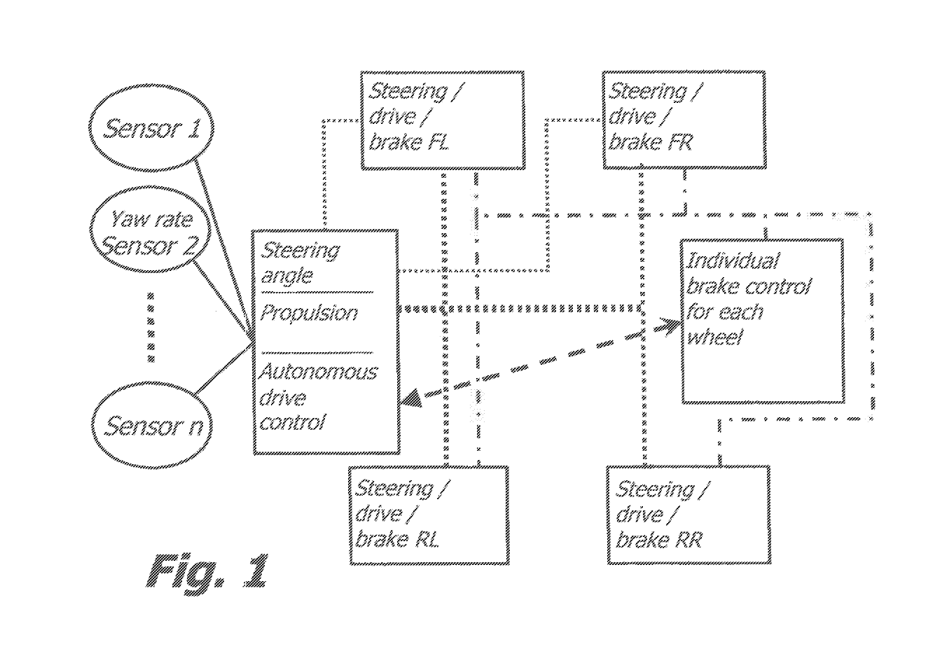

FIG. 1 shows, in schematic form, parts that are of interest here of a control system (autonomous drive control) which is adapted and intended for use in a motor vehicle. This control system has an autonomous drive control. This receives environmental data and intra-system (sensor) data from one or more sensor/s assigned to the motor vehicle. On the basis of these data, the control system intervenes in the driving operation of the motor vehicle, by means of associated actuators (steering, drives, brakes, etc.), in such a manner that an at least semi-autonomous driving operation is effected. To this end, the autonomous drive control communicates either with the actuators (steering, drives, brakes, etc.) directly or with an individual brake control of each wheel indirectly. In the arrangement shown, the autonomous drive control addresses the steering of the front wheels FL, FR and the (electric) wheel drives directly. For individual braking interventions at each wheel, the autonomous drive control sends corresponding commands to the individual brake control of each wheel, which in turn controls the respective wheels FL, FR, RL, RR individually.

In trouble-free operation, the control system is capable of generating actuator signals (steering angle, propulsion) for the autonomous operation of the motor vehicle from the environment sensor data and the intra-system data. The control system is additionally capable of detecting a failure of a conventional steering system of the motor vehicle from the environment sensor data and the intra-system sensor data. This is possible, for example, as a result of the fact that a predetermined steering angle signal does not correspond to a rotation of the motor vehicle about its vertical axis, the rotation being determined with a signal from a yaw rate sensor. This can be established by the system control by comparison.

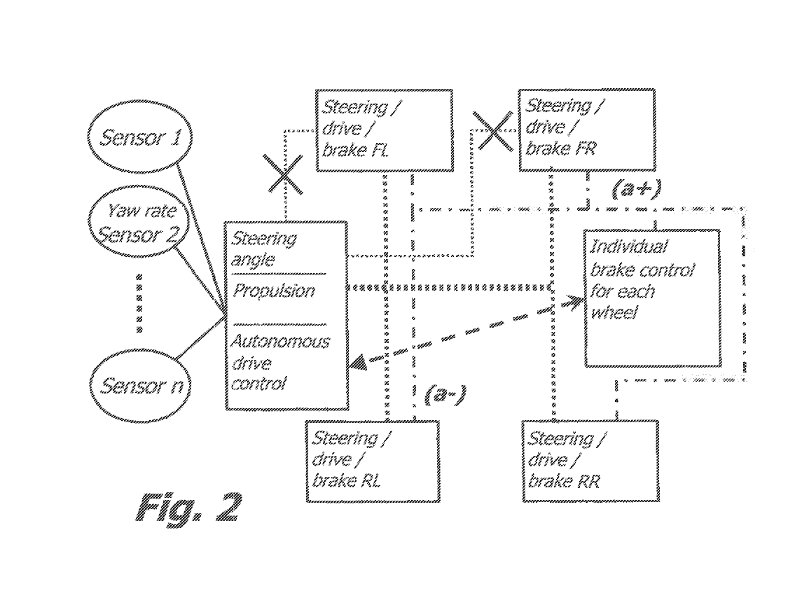

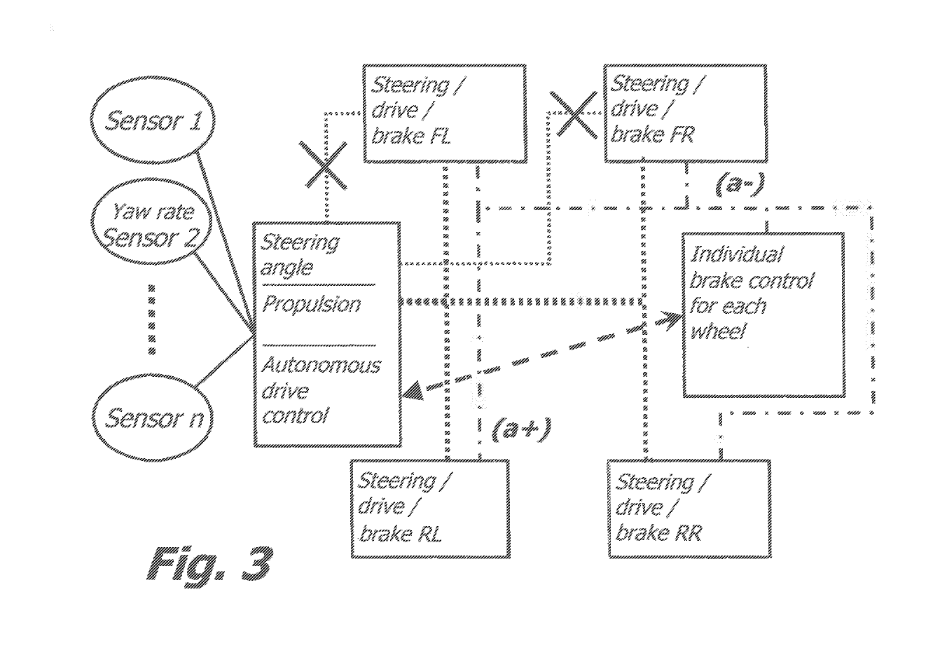

If an exceptional situation is present—shown in FIGS. 2 and 3 by means of broken connections between the autonomous drive control and the steering actuators, which set the steering angle of the front wheels—the control system is capable of attempting a change of direction of the vehicle, which corresponds to a desired steering angle, from current driving parameters by means of matched acceleration and/or deceleration interventions at individual wheel drives or wheel brakes, respectively, of the vehicle.

For the matched acceleration and/or deceleration interventions at individual wheel drives or wheel brakes, respectively, of the vehicle, the control system uses in one solution variant the driving dynamics control system which is (in any case) present in the vehicle. To that end, the autonomous drive control can communicate, for example, with the individual brake control of each wheel of the driving dynamics control system and transmit corresponding commands. The autonomous drive control can check the result of the deceleration interventions again with the yaw rate sensor, for example, and make a re-adjustment

Evaluated driving parameters include in some solution variants: vehicle speed, vehicle acceleration, yaw rate of the vehicle, desired and actual steering angle, speed of individual wheels of the vehicle, and slip state of individual wheels of the vehicle relative to the ground.

The control system effects the matched acceleration and/or deceleration interventions in such a manner that, for a desired change of direction of the vehicle to the left, a left rear wheel of the vehicle is decelerated by application of a braking torque a− and—where possible—a right front wheel of the vehicle is accelerated by application of an acceleration torque a+. Individual acceleration of a (front) wheel of the vehicle is generally possible only in the case of (partially) electric vehicles which have individual electric drives for each wheel (FIG. 2). In an analogous manner, a change in direction of the vehicle to the right is effected by the control system by decelerating a right rear wheel by application of a braking moment a− and—where possible—and/or accelerating a left front wheel of the vehicle by application of an acceleration torque a+ (FIG. 3).

The system architecture illustrated in the figures, in which the various components in communication with one another are connected to one another directly, is not obligatory; the components may also communicate with one another through a data bus.

The variants described above, and the structural and operational aspects thereof, serve merely for better understanding of the structure, mode of operation and properties; they do not limit the disclosure to the embodiments. Some of the figures are schematic, some important properties and effects being shown on a significantly enlarged scale in order to make the functions, principles of operation, technical configurations and features clear. Any mode of operation, principle, technical configuration and feature disclosed in the figures or in the text can be combined freely and as desired with all the claims, any feature in the text and in the other figures, other modes of operation, principles, technical configurations and features which are contained in or follow from this disclosure, so that all conceivable combinations are to be associated with the described variants. Also included are combinations between ail the individual remarks in the text, that is to say in every paragraph of the description, in the claims and also combinations between different variants in the text in the claims and in the figures. The claims also do not limit the disclosure and thus the possible combinations of all the described matures with one another. All the disclosed features are also explicitly disclosed herein individually and in combination with all the other features.

1. A control system which is adapted for use in a motor vehicle and intended to effect an at least semi-autonomous driving operation of the motor vehicle by means of assigned actuators on the basis of environmental data and intra-system sensor data which are obtained from one or more sensor/s assigned to the motor vehicle, and wherein the control system is adapted and intended to detect a failure of a conventional steering system of the motor vehicle and attempt a change of direction of the vehicle, which corresponds to a desired steering angle, from current driving parameters by means of matched acceleration and/or deceleration interventions at individual wheel drives or wheel brakes, respectively, of the vehicle.

2. Control system according to claim 1, in which the driving parameters include one or more of the parameters: vehicle speed, vehicle acceleration, yaw rate of the vehicle, desired and actual steering angle, speed of individual wheels of the vehicle, and slip state of individual wheels of the vehicle relative to the ground.

3. Control system according to claim 1, in which the control system is adapted and intended to effect the matched acceleration and/or deceleration interventions in such a manner that, in order to effect a change of direction of the vehicle to the let, a left rear wheel of the vehicle is decelerated and/or a right front wheel of the vehicle is accelerated.

4. Control system according to claim 1, in which the control system is adapted and intended to effect the matched acceleration and/or deceleration interventions in such a manner that, in order to effect a change of direction of the vehicle to the right, a right rear wheel of the vehicle is decelerated and/or a left front wheel of the vehicle is accelerated.

5. Method of effecting an at least semi-autonomous driving operation of a motor vehicle on the basis of environmental data obtained from one or more environment sensor/s assigned to the vehicle by means of an electronic control and by means of actuators downstream of the control of the motor vehicle, comprising the following steps:
detecting the presence of an exceptional situation because of an at least partial failure of components of a steering system of the motor vehicle; and
attempting a change of direction of the vehicle, which corresponds to a desired steering angle, from current driving parameters by means of matched acceleration and/or deceleration interventions at individual wheel drives or wheel brakes, respectively, of the vehicle.

6. Method according to claim 5, in which there are evaluated as the driving parameters one or more of the parameters: vehicle speed, vehicle acceleration, yaw rate of the vehicle, desired and actual steering angle, speed of individual wheels of the vehicle, and slip state of individual wheels of the vehicle relative to the ground.

7. Method according to claim 5, in which the matched acceleration and/or deceleration interventions are effected in such a manner that, for a change of direction of the vehicle to the left, a left rear wheel of the vehicle is decelerated and/or a right front wheel of the vehicle is accelerated.

8. Method according to claim 5, in which the matched acceleration and/or deceleration interventions are effected in such a manner that, for a change of direction of the vehicle to the right, a right rear wheel of the vehicle is decelerated and/or a left front wheel of the vehicle is accelerated.
